(19) United States
(12) Patent Application Publication
(10) Pub. No.: US 2015/0039121 A1
(43) Pub. Date: Feb. 5, 2015

(54) 3D MACHINE VISION SCANNING INFORMATION EXTRACTION SYSTEM

(71) Applicant: HERMARY OPTO ELECTRONICS INC., Coquitlam (CA)

(72) Inventors: Terrance John HERMARY, Coquitlam (CA); Alexander Thomas HERMARY, Belcarra (CA); Mohammad Reza SAHRAEI, North Vancouver (CA)

(73) Assignee: HERMARY OPTO ELECTRONICS INC., Coquitlam (CA)

(21) Appl. No.: 14/305,441

(22) Filed: Jun. 16, 2014

Related U.S. Application Data
(63) Continuation-in-part of application No. 14/125,089, filed on Dec. 10, 2013.

(51) Int. Cl. G05B 19/4097

(52) U.S. Cl. CPC G05B 19/4097; G05B 2219/35075
USPC 700/163

(57) ABSTRACT

A 3D machine vision scanning system having a scanner head for obtaining raw scan data from a target object, an information extraction module that processes and reduces the raw scan data into target object information that is to be used for automated control decisions in an industrial process, and a communication interface for transmitting the target object scan information to a controller.

### RELATED APPLICATIONS

This is a continuation-in-part application of application Ser. No. 14/125,089 filed on Dec. 10, 2013, which is a National Stage Application of International Application No. PCT/CA2012/050390 filed on Jun. 11, 2012, which claims the priority of Canada Application No. 2743016, filed on Jun. 10, 2011, all of which are hereby incorporated by reference.

### FIELD OF INVENTION

This invention relates to the general field of devices that remotely measure the dimensions of objects, and more specifically to three-dimensional (3D) machine vision scanners with integral data reduction or computation methods that permit a direct interface with common industrial controllers.

### BACKGROUND OF THE INVENTION

Machine vision (MV) is a branch of engineering that uses computer vision in the context of manufacturing. “MV processes are targeted at recognizing the actual objects in an image and assigning properties to those objects—understanding what they mean.” (Fred Hapgood, Factories of the Future, Essential Technology, Dec. 15, 2006)

“A 3D scanner is a device that analyzes a real-world object or environment to collect data on its shape and possibly its appearance. The collected data can then be used to construct digital, three dimensional models. The purpose of a 3D scanner is usually to create a point cloud of geometric samples of the surface of the subject. These points can then be used to extrapolate the shape of the subject.” [3D scanner, Wikipedia]

The use of 3D scanners as machine vision for industrial manufacturing create a fundamental challenge when scanners generate increasingly larger amounts of scan data because that data must necessarily be reduced to fit into an industrial controller in a timely fashion or the process breaks down. As Moore's Law anticipates ever finer grained point clouds, the primary issue becomes effective real-time data management. If one uses a 3D scanner to create information about objects that allow industrial equipment to operate on said objects quickly and accurately, the data flow must be limited to only that which is needed to perform said task.

Currently XYZ data clouds of half a million points per second are sent to a PC interface which must analyze and process the data into information that an industrial controller can utilize. Employing multiple PCs require programming and engineering expertise to abstract the relevant information from a point cloud or a series of 2D slices in quantities small enough that a simple industrial controller can utilize them effectively. Unfortunately that processing is often too slow to be acted upon in time by the controller, a delay which is often costly, wasteful, and sometimes dangerous in an industrial manufacturing or processing environment.

Prior art scan data pre-processing techniques can be found in fields such as digital camera imaging systems (U.S. Pat. No. 7,791,671), POS scanners (U.S. Pat. No. 6,085,576), and defect detection systems (U.S. Pat. No. 7,783,103), but all require additional processing by a central unit external from the scanning device. A small step closer is the employment of a field-bus environment (U.S. Pat. No. 7,793,017) where data from multiple sensors is converted to a common addressable protocol network, but this does not effectively address the required analysis of 3D scanner data for near-realtime controller utilization. A triangulation scanning platform (U.S. Pat. No. 7,812,970) used for inspecting parts generates datasets that are processed by linear encoder electronics in order to control the rate of linear movement of the object being scanned, but do not feed near-real-time scan data to an industrial controller.

Another concern is that a majority of 3D scanning systems employ 2D area image capture methods which stitch together 2D snapshots to form a 3D wire-frame model. This is not true 3D scanning and requires many problematic and inefficient solutions that are difficult to implement.

Off the shelf, stand alone scanner units with protocol integrated data load management techniques applied to 3D machine vision scanning have not been found in the prior art and are needed to simplify and optimize industrial processing and manufacturing in many fields.

### SUMMARY OF THE INVENTION

A 3D machine vision scanner is traditionally designed to extract all relevant process data from each object scan and then send it directly to industrial process & manufacturing controllers. 3D scanners employed for industrial processes (MV) can generate a set of 2D slices which can be ‘stacked together’ to produce a 3D representation. The novel device generates a 3D model from 2D slices that have been reduced by customizable information extraction tools & methods so that the volume of scan data sent to a controller is more manageable and can be used more quickly. By this means more raw data can be processed or summarized onboard the 3D scanner unit and then be sent directly to an industrial controller for process control, effectively in real time.

Directly interfacing a 3D scanner with an industrial controller and providing it thereby with extracted information that is significant for the controller's decision-making—rather than voluminous raw scan data—eliminates the need for a middleman processor to receive and process a large data cloud, while it also gives the process engineer much more direct control over the scanning output parameters without dependence on the scanner manufacturer to reconfigure the device for every new scan. A 3D machine vision scanner system embodying the present invention summarizes large amounts of data very quickly in a format industrial controllers can utilize so they can control, or make decisions based on, the item or items being scanned.

A 3D machine vision scanner system can be utilized to improve many industrial and manufacturing processes. These include, but are not limited to scanning logs for trimming or cutting in a wood processing plant; detecting weld seam defects made by a robotic welder; accurately measuring the low point of a very large irregular surface for trimming; automatically culling fruit (or any object) by size or shape; measuring frozen pizza to ensure it will fit its box; tracking edges of rewinding spools to prevent wandering and tangling; accurately measuring object parameters to prevent accumulated errors when stacked; detecting imperfections in extrusions or pipes; accurately estimating volume of loose objects such as frozen foods for optimal refrigeration capacity, or woodchips/cereals to derive moisture content, etc. At present all of these processes require human counting, expert programming skills, database management, and data processing and are often expensive, labor and time consuming, and not always accurate or automatic.

The present invention provides a three-dimensional machine vision system having a scanner head comprising a camera and a computer that functions as an information extraction module that performs data reduction and passes summary data to facilitate a direct significant information interface with common industrial controllers. By directly delivering key summaries of data from the scanner to the controller, the process engineer regains control of the scanning parameters as well as the decision processing. Scanner output and implementation is compatible with common industrial communication protocols used by process engineers in many fields. Raw 3D geometric measurements in a Cartesian coordinate system can be re-mapped into machine coordinates for industrial applications. Extracted information 3D machine vision scanning provides simpler, faster and more cost effective manufacturing and processing.

Essentially, the invention provides a 3D machine vision scanning system having:

1. a scanner head for obtaining raw scan data from a target object,
2. an information extraction module that processes and reduces the raw scan data into target object information that is significant for automated control decisions in an industrial process, and
3. a communication interface for transmitting the target object scan information to a controller.

The scanner head traditionally contains a laser light emitter and a reflected laser light detector. A scanner head embodying the present invention would also contain the information extraction module and the communication interface. The information extraction module has a set of embedded mathematical functions to extract key target object information from scan data, in order to reduce data transmission, system stalling and complexity of subsequent processing and decision analysis in an industrial control system.

In a preferred embodiment:

a) the computation method to be used by the information extraction module is selectable by the controller, choosing from a set of key scan information extraction tools embedded in data processing computer hardware that is integrated along with a laser projector, an imaging reflected laser sensor and into a sealed scanner head;
b) the target object scan information is derived only from scan data of a region of interest selected by the controller within a larger zone capable of being scanned by the scanner head;
c) the key scan information extraction tools include a multiplicty of predefined, controller-selectable regions of interest;
d) an information extraction tool is applied to scan data from a controller-selectable range of number of scan profiles, and resulting scan information is transmitted to the controller, before the information extraction tool is applied to a subsequent number of scan profiles selected;
e) the scanner head extracts key scan information from raw profile (X-Y) scan data and passes to the controller only the scan information that the controller needs to perform its functions.
f) the key target object scan information is formatted within the scanner head into an open standard communication protocol;
g) the scanner head summarize large amounts of target object scan data rapidly and passes on via a communication interface to an industrial controller a vastly smaller data set of summary target object scan information in a format industrial controllers can utilize to make industrial process control decisions.

The scanner head would be installed in an industrial setting such as a packaging or assembly conveyor line, in which application decision processing about target objects scanned by the scanner is done by a controller.

The scanner head can be combined with multiple like scanners connected to a communication multiplexer encoder that includes time division synchronization so each scanner can be phase locked. This provides that one scanner head can fire its laser and obtain a scan profile without interference while the others in the array of multiple scanners are off and waiting their turn to scan sequentially.

### BRIEF DESCRIPTION OF THE DRAWINGS

FIG. 1a shows 3D scanners connected to an encoder/multiplexer and PC Interface which process scan data for an industrial controller.

FIG. 1b shows the much simpler external elements of a 3D Machine Vision Scanning Information Extraction System.

FIG. 2a shows the active side view of a 3D scanner housing.

FIG. 2b shows a diagram of how a 3D scanner creates X-Y profiles.

FIG. 2c shows an isometric interior view of the scanner operation as it scans a section of board with a distinctive profile.

FIG. 2d shows an isometric view of the operational scan zone of a 3D scanner and a sample scan of an object by means of a fan of laser light emitted from the scanner.

FIG. 2e shows an isometric inside view of the operational scan zone of a 3D scanner and a sample scan of an object by means of a fan of laser light emitted from the scanner.

FIG. 3a shows a photograph of an orange being scanned.

FIG. 3b shows an isometric point cloud of the scan of the orange.

FIG. 3c shows a side view of the point cloud of the orange.

FIG. 4a shows a side view of the point cloud with profile extrema.

FIG. 4b shows a side view of the profile extrema of the orange.

FIG. 5a shows a side view of the profile and cloud extrema.

FIG. 5b shows a top view of the profile and cloud extrema.

FIG. 6a shows a photograph of a pizza being scanned.

FIG. 6b shows an isometric view of the scan of a pizza including its point cloud with profile extrema.

FIG. 6c shows a top view of the scan of a pizza including its profile and cloud extrema.

FIG. 7 shows an Extrema Derivation Chart

FIG. 8a shows a dented section of corrugated pipe being scanned.

FIG. 8b shows a graph of the moment when the scanner IET detects the dent as a divergence from the pipe's nominal profile.

FIG. 9a shows a photograph of a pile of woodchips being scanned.

FIG. 9b shows an isometric view of the 3D scan of the woodchips.

FIG. 10a shows a side view of the 3D scan of the woodchips.

FIG. 10b shows a chart illustrating the area summing of a single profile of the woodchip scan within a selected region of interest.

FIG. 11a shows a Venn diagram illustrating how the information extraction module with a set of information extraction tools (IET) enables 3D Machine Vision Scanning Information Extraction.

FIG. 11b shows elements integrated into a 3D Machine Vision Scanning Information Extraction System.

FIG. 11c shows a system overview illustrating operational implementation of an Ethernet 3D Machine Vision Scanner.

FIG. 12 shows a plot of curvature maxima extraction (apex & antipex) from raw profile data.

### DETAILED DESCRIPTION

The 3D Machine Vision Scanning Information Extraction System will now be described by reference to figures and critical terminology will be discussed.

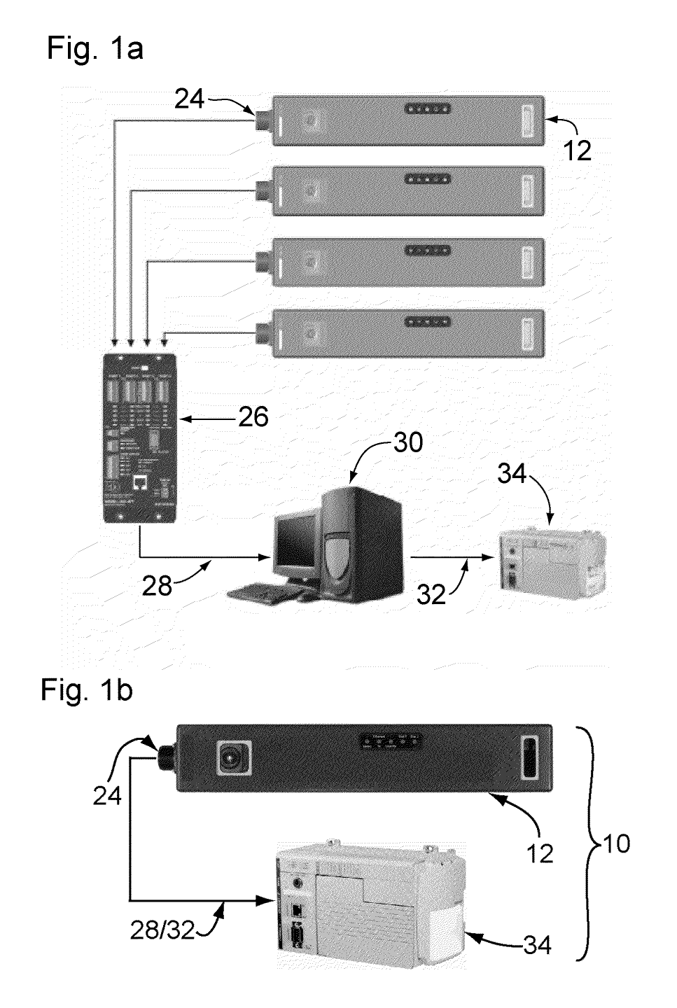

FIG. 1a shows a number of scanners 12 sending scan data from each scanner output 24 to a multiplexer/encoder 26, then by means of an ethernet industrial protocol (EtherNet/IPTM) 28 connection to a workstation/PC Interface 30, which analyzes and processes the data and converts it into a Common Industrial Protocol (CIPTM)—CIP and EtherNet/IP are trademarks of ODVA, which is an international association comprising members from the world's leading automation companies. Collectively, ODVA and its members support network technologies based on the Common Industrial Protocol (CIP). These currently include DeviceNet, EtherNet/IP, CompoNet, and ControlNet, along with the major extensions to CIP CIP Safety and CIP Motion. All these trademarks are of ODVA, which manages the development of these open technologies, and assists manufacturers and users of CIP Networks through its activities in standards development, certification, vendor education and industry awareness. The CIP 32 formatted information is transmitted to an industrial controller 34 (Prior Art). FIG. 1b shows the two external elements of a 3D Machine Vision Scanning Information Extraction System 10, namely a scanner 12 sending summarized CIP 32 data from its output 24 via EtherNet/IP 28 directly to the controller 34. (Internal data processing elements will be discussed below.)

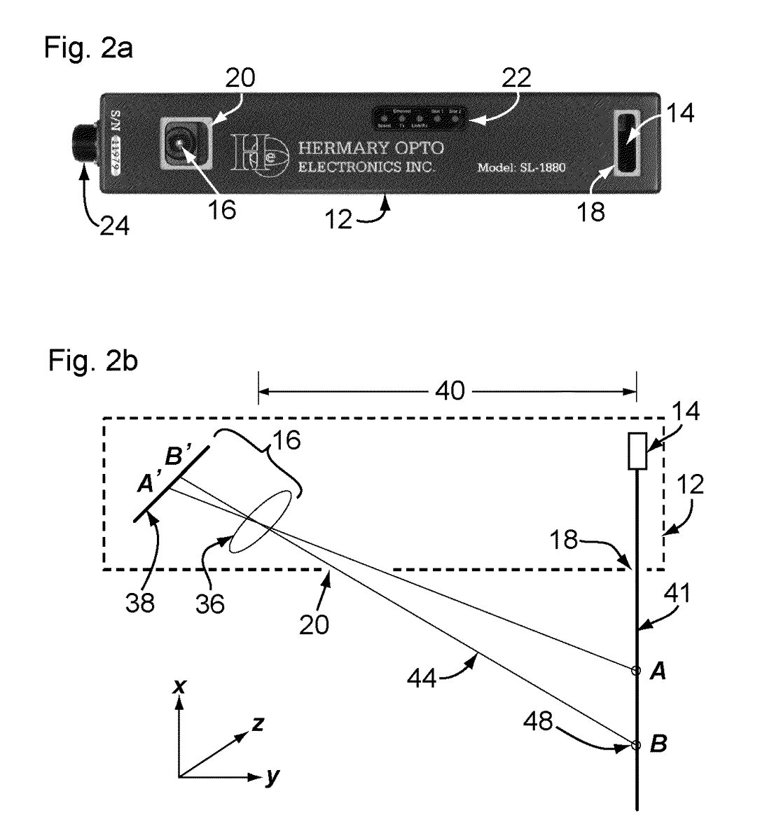

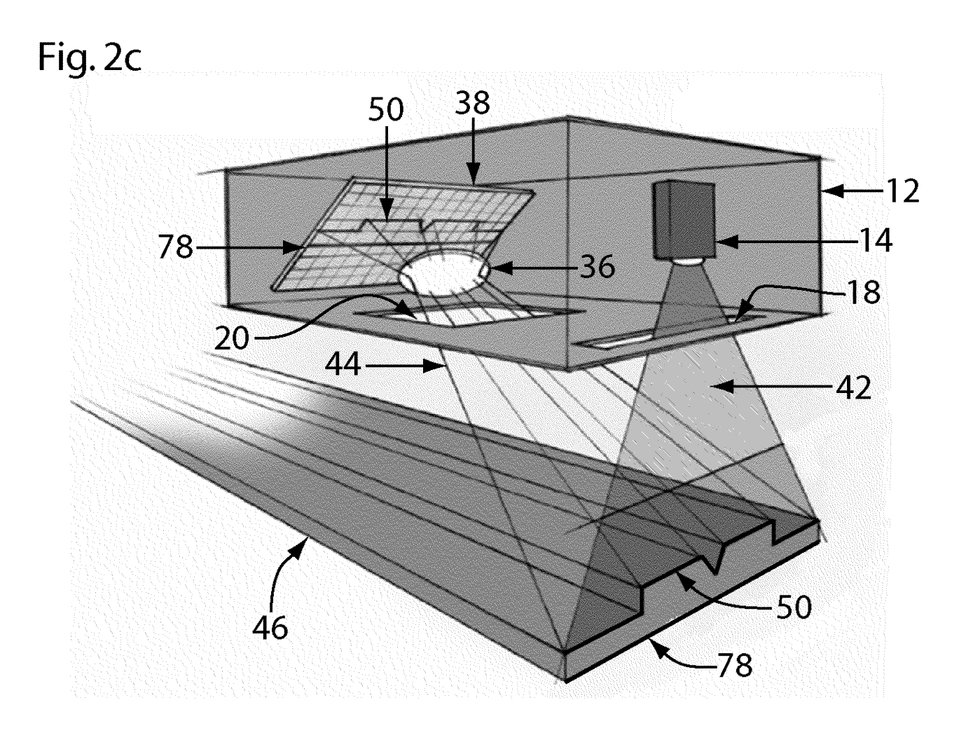

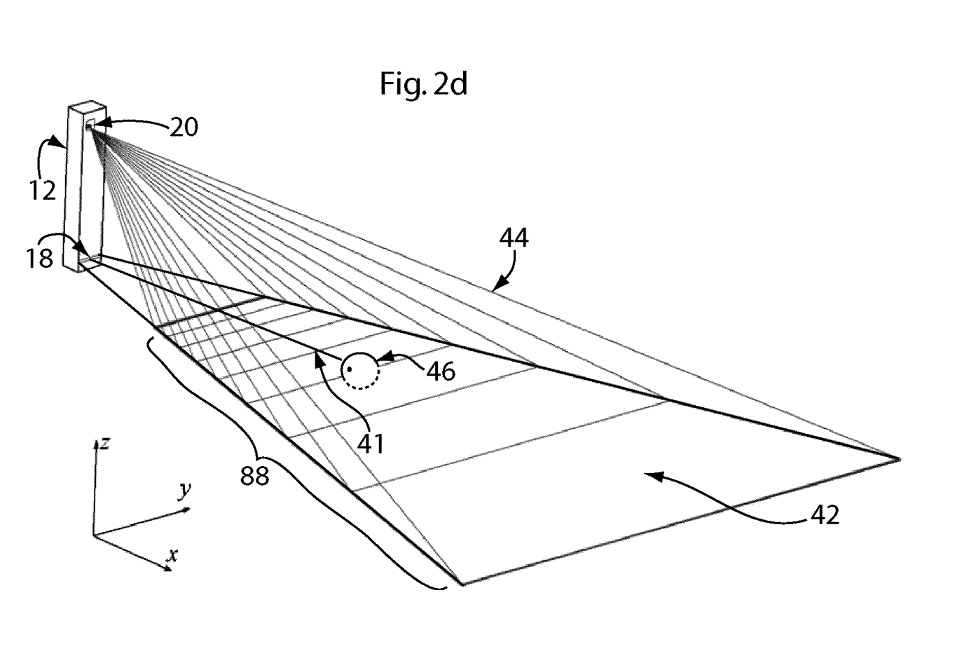

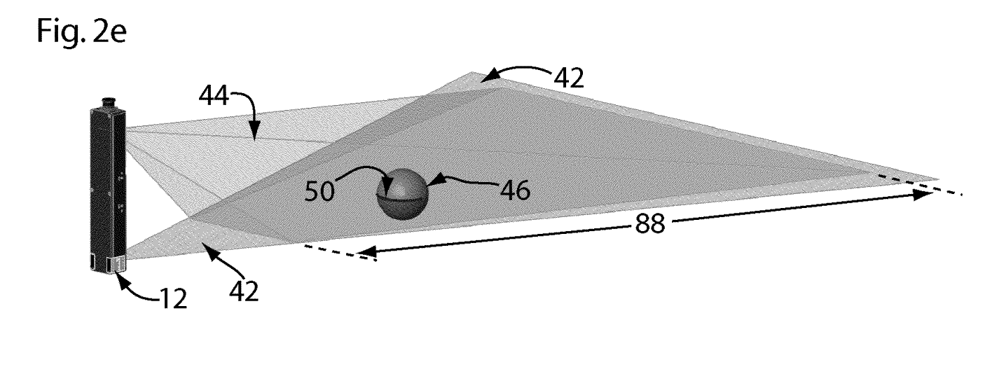

FIG. 2a shows the active side view of a 3D scanner housing unit 12 with a laser projector 14 emitting coherent light through its window 18, a camera 16 viewing through its window 20, an indicator panel 22 and the scanner output 24 connector.

FIG. 2b shows a diagram of a scanner 12 operating a laser projector 14 which sends a beam 41 through its window 18 onto an object (not shown) at a point 48 labeled A. The laser beam 41 on the object (between points A & B) is imaged by a sensor 38 at A′ by means of a return path 44 through the field of view of the camera lens 36. As the laser projector 14 reaches point B on the object its position has correspondingly changed on the sensor 38 to B′. Since the baseline 40 is known, and the laser corner is a right angle, the angle of the camera corner can be determined from the location of the laser dot in the camera's field of view as detected by the sensor 38. To speed up the acquisition process, the laser projector 14 actually emits a sheet of laser light, hereafter known as a laser fan 42 in order to derive an X-Y profile 50 of the item being scanned.

FIG. 2c shows an isometric interior view illustrating the scanner 12 operation as it emits a laser fan 42 over an object 46, here a section of board with a distinctive profile 50, and then images it along the return path 44 through the lens 36 onto the imaging sensor 38. The actual image of the profile 50 created by the laser fan 42 as shown on the surface of the sensor 38 is merely representative of the scanning operation in order to illustrate the principles involved. The orientation and size of the image of the profile 50 received by the sensor 38 depends on the characteristics of the lens 36 and imaging distance.

FIG. 2d shows the operational scan zone 88 of a scanner 12 emitting laser fan 42 from laser window 18. The profile 50 of an object 46 (an orange) placed within the scan zone 88 will be painted by the laser fan 42 and be imaged along the return path 44 through the camera window 20. The laser emitter does not pivot—rather, the laser light emitted is refracted into a planar fan, the reflection of which off the target object is detected by a camera The profile 50 is the set of detected laser intersection points upon the surface of the target object, and is a subset of the actual surface section atomic anatomy of the target object.

FIG. 2e shows the inside view of FIG. 2d wherein the profile 50 painted by the laser fan 42 on the object 46 is now visible as it is seen through the camera window 20 via the return path 44.

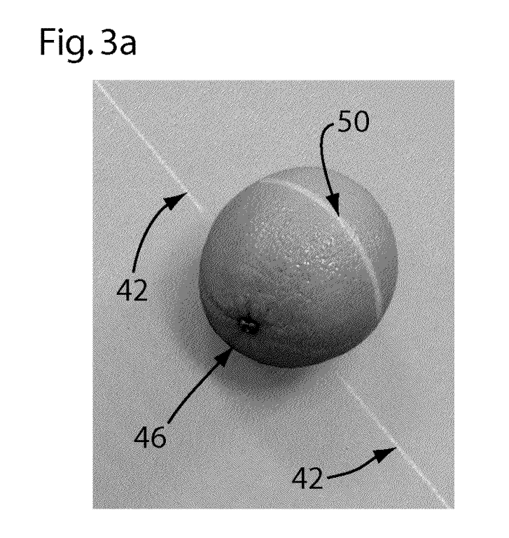

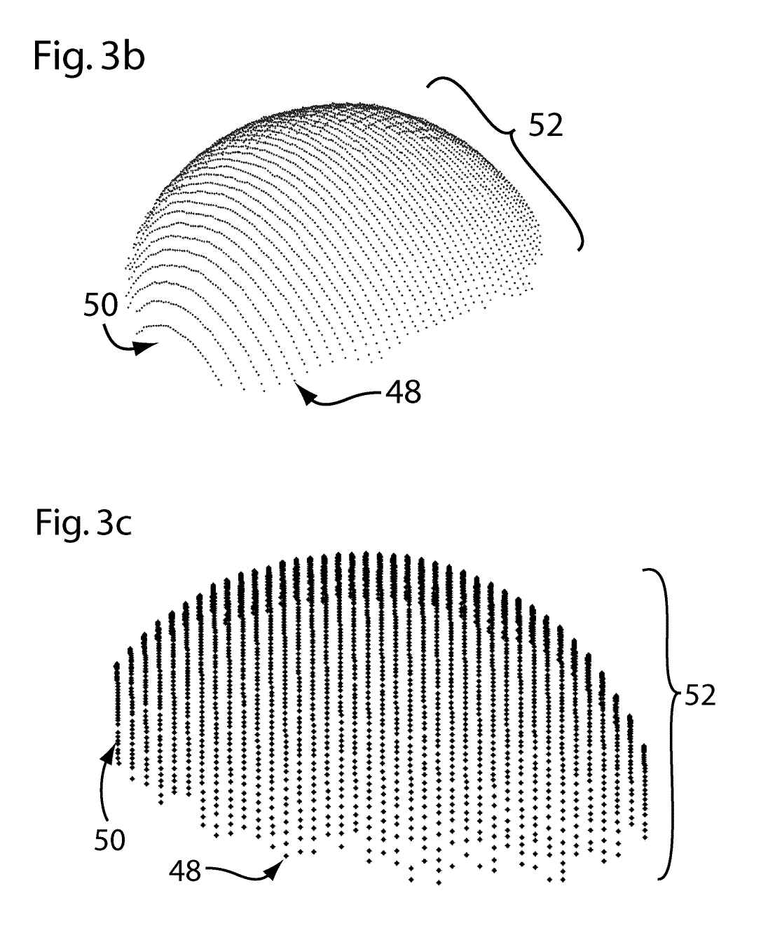

FIG. 3a shows an isometric photograph of an orange (object 46) being scanned by a laser beam 42 and highlighting the orange's profile 50. FIG. 3b shows an isometric view of the point cloud 52 of a section of the orange 46, comprised of successive profiles 50 of individual points 48. FIG. 3c shows a side view of the point cloud 52 of a section of the orange 46, comprised of successive profiles 50 of individual points 48. FIGS. 3b & 3c illustrate raw 3D scan data comprised of successive X, Y profile scans incremented along the Z Axis.

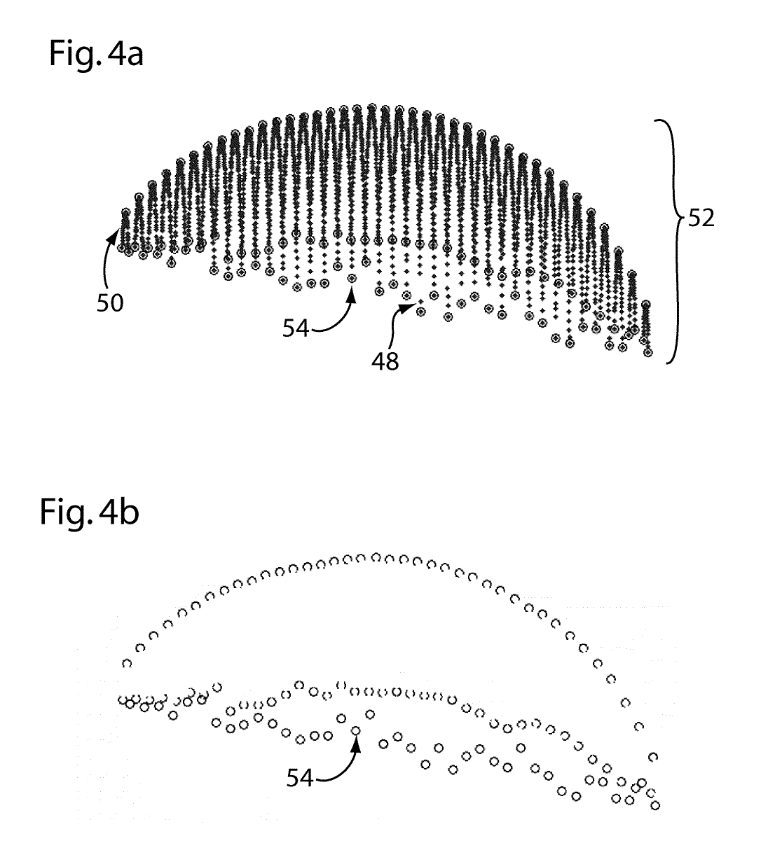

FIG. 4a shows a side view of the point cloud 52 of a section of the orange 46 wherein profile extrema 54 of selected points 48 for each profile 50 are highlighted with small thin circles. FIG. 4b shows a side view of only the profile extrema 54 of the same section of the scanned orange 46.

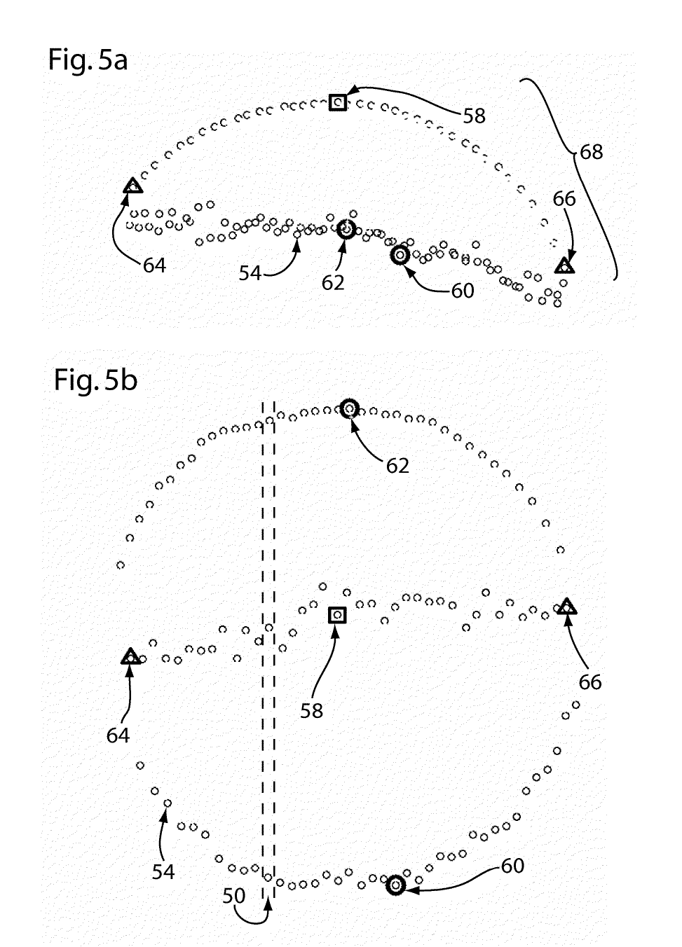

FIG. 5a shows a side view of the profile extrema 54 of the section of the orange 46 scanned and selected cloud extrema 68 marked to denote their axis, namely X min 56 & X max 58 by squares, Y min 60 & Y max 62 by circles, and Z min 64 & Z max 66 by triangles. FIG. 5b shows a top view of the profile extrema 54 of the section of the orange 46 scanned and selected cloud extrema 68 as above. Also shown by broken lines in FIG. 5b is a single profile 50 with its extrema 54 as illustrated in FIG. 5a above.

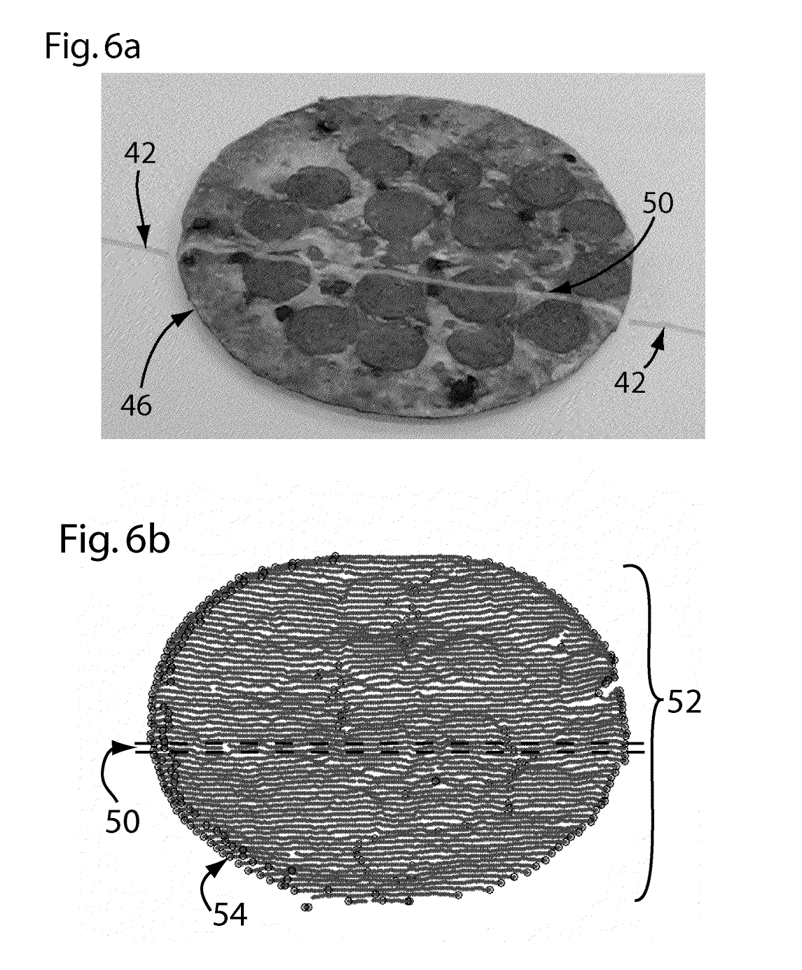

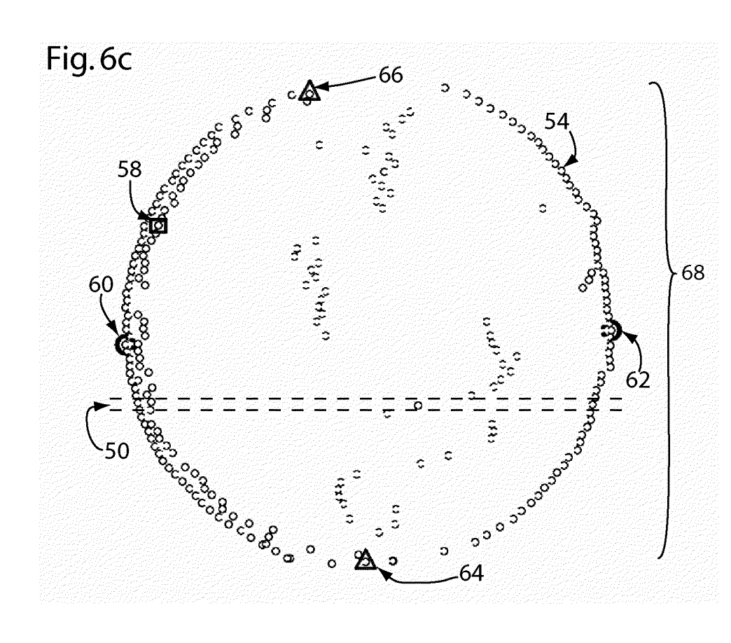

FIG. 6a shows an isometric photograph of an object 46 (pizza) being scanned by a laser beam 42 and highlighting its profile 50. FIG. 6b shows an isometric view of the point cloud 52 of a pizza 46 collated from single profile 50 scans and highlighting profile extrema 54. FIG. 6c shows a top view of the scan of a pizza 46 showing its profile extrema 54 and highlighting selected cloud extrema 68 as shown in FIGS. 5a/b. Also shown by broken lines is a single profile 50 with its extrema 54.

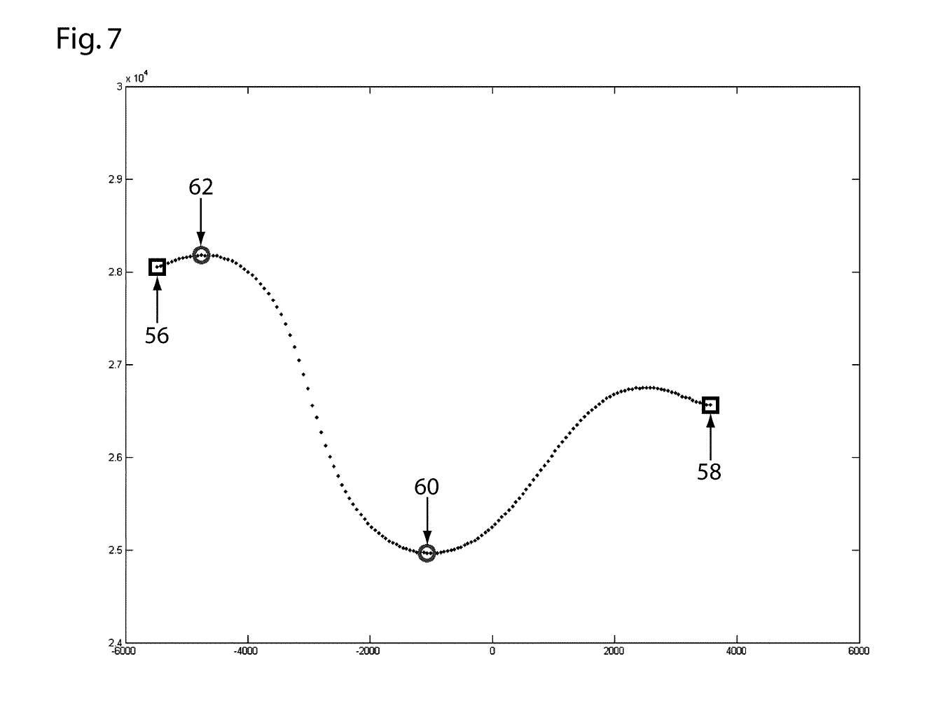

FIG. 7 shows an Extrema Derivation Chart employing the same extrema labeling legend as in cloud extrema 68, namely X min 56 & X max 58 show the extremes along the X axis, and Y min 60 & Y max 62 show the extremes in the Y direction.

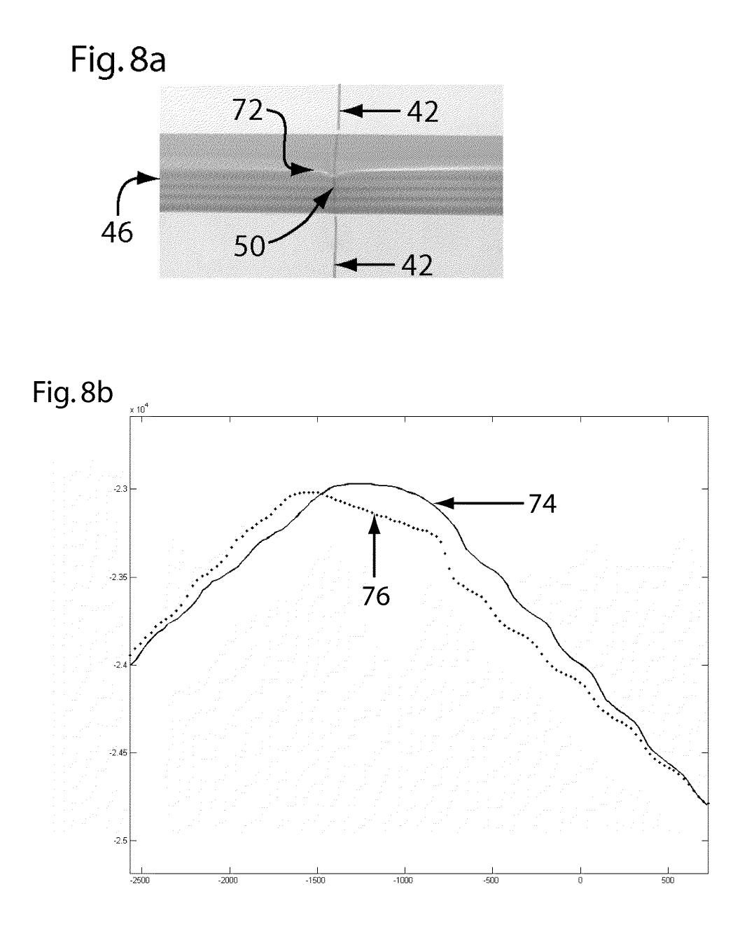

FIG. 8a shows a dented section of corrugated pipe (object 46) being scanned by a laser beam 42 and forming its profile 50 as it crosses the dent 72. FIG. 8b shows a graph highlighting the moment when the scanner's internal information extraction module's calculations detect the dent 72 as a divergence 76 from the pipe's 46 nominal profile 74.

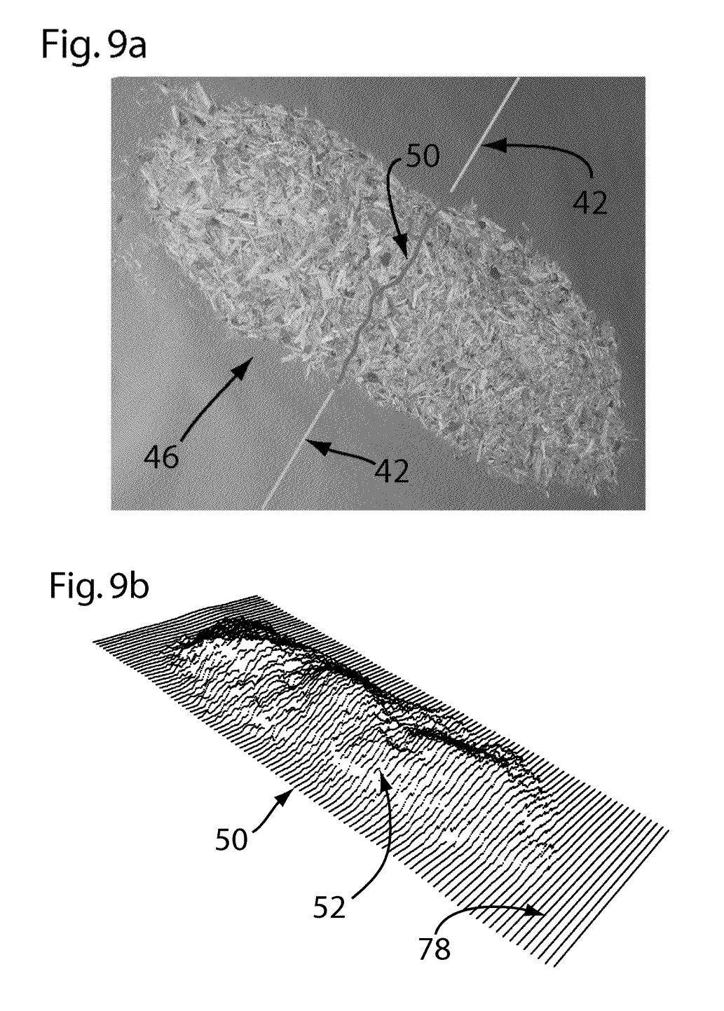

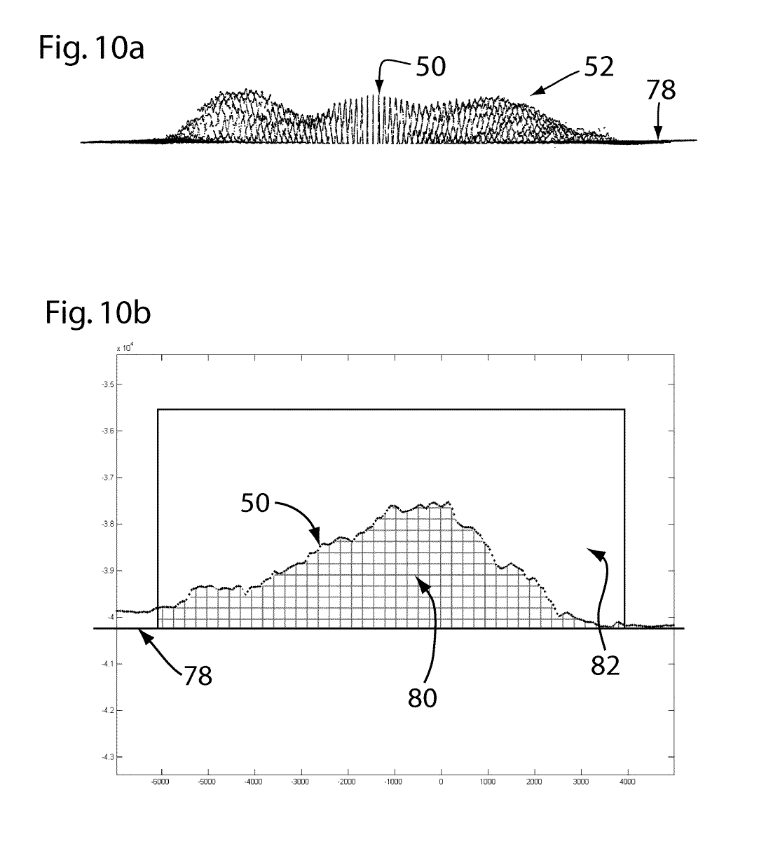

FIG. 9a shows an isometric photograph of a pile of loose woodchips (object 46) being scanned by a laser beam 42 and creating a profile 50. FIG. 9b shows an isometric view of the 3D point cloud 52 accumulated from the profile scans 50 of the woodchips 46. Also shown is a software selectable region of interest (ROI) the horizontal rectangle ROI 78. The controller by selecting an ROI thereby tells the scanner 12 to extract information, for transmission to the controller, only from scan data that is within the selected ROI.

FIG. 10a shows a side view of the 3D point cloud 52 accumulated from the profile scans 50 of the woodchips 46, and the horizontal rectangle ROI 78 in side view. FIG. 10b shows a chart illustrating the profile area 80 summing of a single profile 50 of the woodchip 46 scan within a selected vertical ROI 82, that rises from the horizontal rectangle ROI 78. It is convenient to define rectangles as regions of interest in a Cartesian plane, but an ROI could be defined as any shape, such as a circle or ellipse, in a plane, or a even a sphere or other 3D ROI within the scan zone.

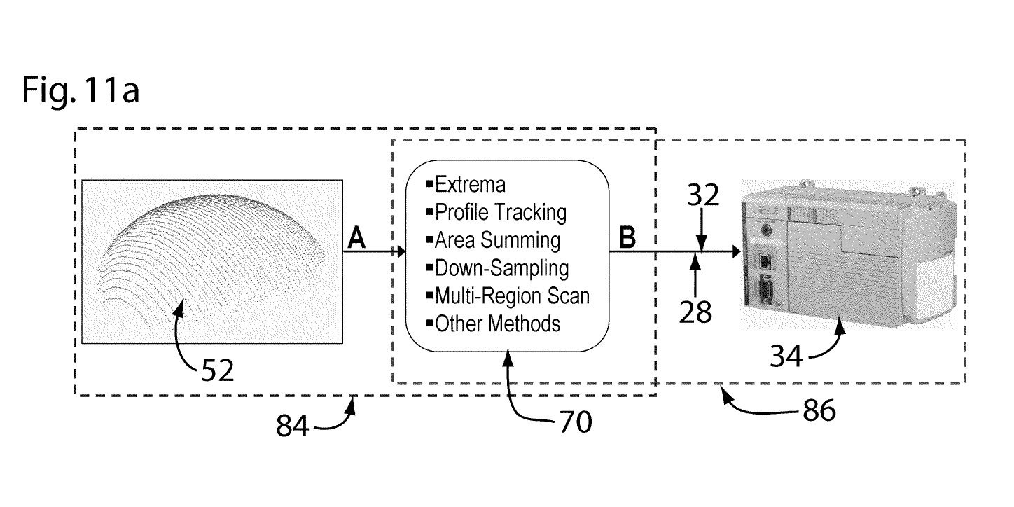

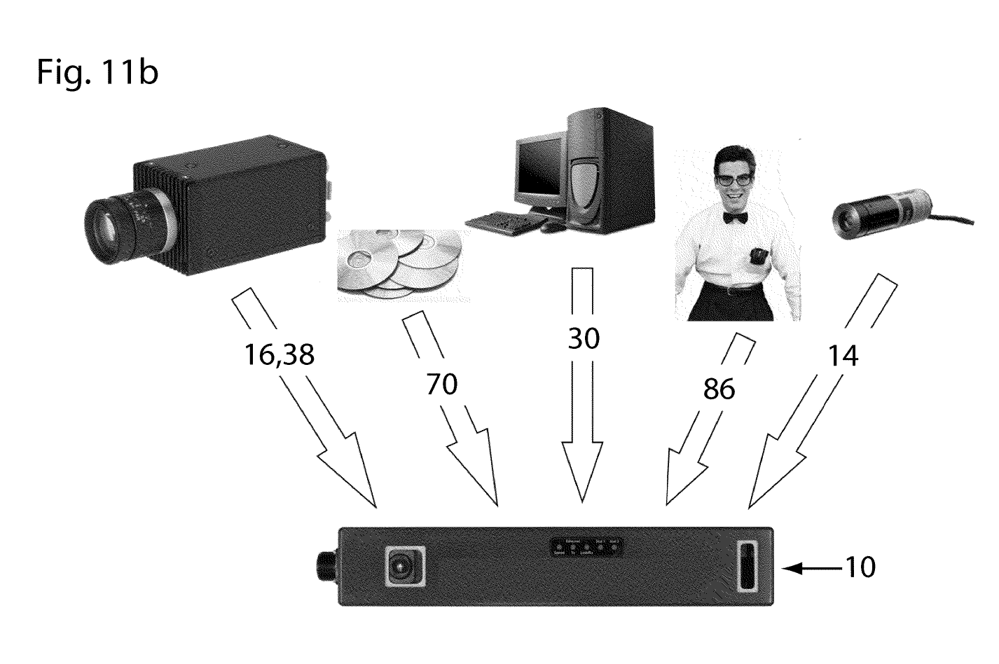

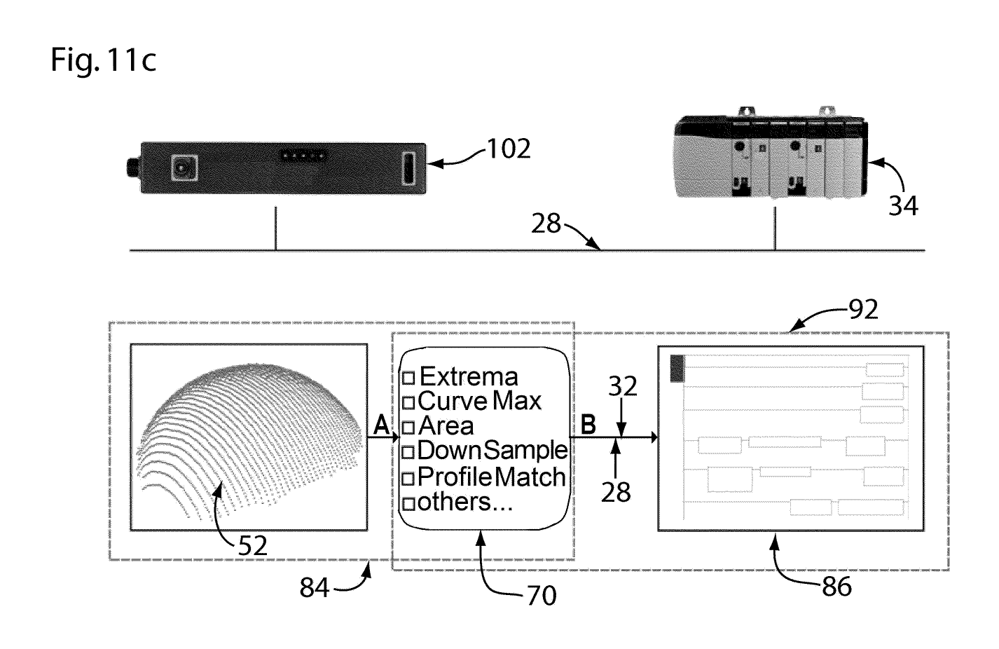

FIG. 11a shows a Venn diagram illustrating the core integration of the Profile extraction 84 and Decision Processing 86 aspects of 3D Machine Vision Scanning Information Extraction 10. Profile extraction 84 of unmanageable raw scan data (point A) by means of information extraction module 70 (in which a set of information extraction tools (IET) is listed) is able to send a manageable amount of data (point B) in a CIP 32 compatible format within an EtherNet/IP 28 communication infrastructure to the controller 34. FIG. 11b shows an overview of some of the elements that are integrated into a 3D Machine Vision Scanning Information Extraction System 10, including camera 16 & sensor 38, information extraction module 70 with the media above representing its set of embedded information extraction tools, workstation/PC interface 30, decision processing 86 and laser projector 14. FIG. 11c shows an alternate system overview illustrating operational implementation the Ethernet 3D Machine Vision Scanner 102.

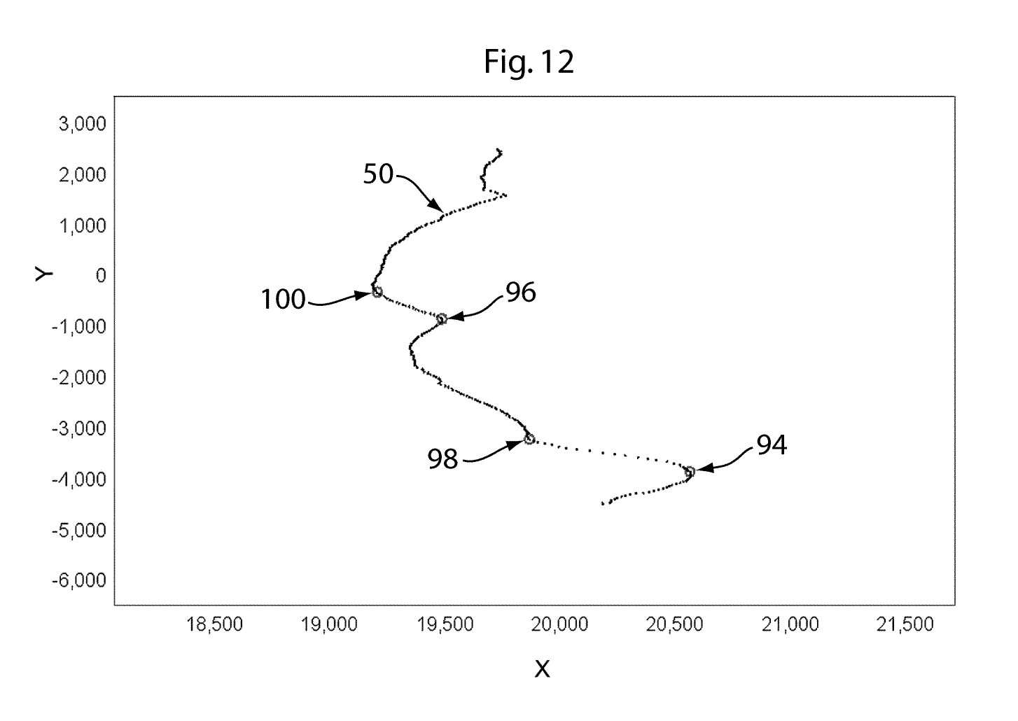

FIG. 12 shows a plot of curvature maxima IET extraction (antipex; 94/96 & apex; 98/100) from raw profile 50 data.

The scanner 12 unit shown in FIG. 2a is a fully sealed, industrial grade package that houses the laser projector 14 imaging system (camera 16, sensor 38) and scan data processing electronics. The scanner 12 scans by having a laser emit coherent light that is refracted into a planar fan. The laser light fan reflects off a profile on the target, that is, off one slice of the surface of an object 46 at a time, the process being incrementally advanced along the Z axis for successive slices. Z coordinates are embedded in the scanner output 24. Multiplexer/Encoder 26 card enables communication from scanners to the processor including timing synchronization so each scanner can be phase locked (preventing overlapping lasers), and allows several scanners to be multiplexed. TCP/IP used with CIP 32 (Common Industrial Protocol) is designated EtherNet/IP 28. A point 48 is one laser projector 14 dot imaged by the sensor 38 and designated by a coordinate in the X, Y plane. (see FIG. 2b, A&B) A profile 50 is a series of imaged points 48 in the X, Y plane, comprising a figurative imaging slice of the scanned object. (see FIG. 3c) A cloud 52 (from point cloud) is a series of profiles 50 along the Z axis that comprises the entire 3D scan of that portion of the object 46 visible to the sensor 38 (within the ROI 82 & above the horizontal rectangle ROI 78.)

The preferred embodiment of the 3D Machine Vision Scanning Information Extraction 10 will now be discussed. The novelty and advantage of the disclosed scanning system depends on the integration of three related aspects of its design, namely its 3D scanning process, information extraction tools, and decision processing application. Each aspect will be discussed separately and then as an integrated system.

### 3D Machine Vision Scanning:

The 3D scanning process employed by the present invention is not the kind where a 2D image (X-Y plane intensity map) or “picture” of an object is captured and then stitched together with other images to form a “3D map” of an object. This method is not true 3D scanning, and has many drawbacks such as being limited to an “in focus plane” and requiring adequate external illumination to be able to scan accurately. Also an area camera (2d image processor) requires many kinds of information to perform optimally such as target distance, focal length, camera pixels, lighting variations, registration marks for orientation of objects, pixel mapping to infer geometric shapes, brightest/darkest spot metering, area calculation, and edge detection for different planes. Also, each vendor has specialized proprietary solutions that require engineering and optical expertise to process. Custom 3D design from 2D area camera input is expensive and requires much re-engineering and cross discipline expertise to implement. Some technicians try to use 2D area cameras to solve 3D problems, but the resulting systems are typically complex, finicky, error-prone, and operator-dependent, and are typically capable of performing simple 3D tasks such as finding the position of an object or bar code, rather than difficult 3D tasks such as mapping shape or extremes of points of shape. Ultimately, “2D” versions of “3D” derived from 2D are not a true form of 3D, too many inferences are required for useful output, and there is no connection to 3D coordinate systems for mapping onto other systems.

The 3D scanning process employed by the present invention uses the method of laser triangulation to image the intersection of an object 46 and the reference laser beam 42 to generate X-Y profiles (or slices) that are then combined incrementally along the Z-axis into a 3D point cloud representation (XYZ). 3D laser triangulation works as follows: (see FIG. 2b) A projected reference beam 42 hits a target (A,B), which is imaged on a sensor 38, and distance to target can be computed by triangulation. Multiple simultaneous readings can deliver an X,Y profile 50 (FIGS. 2c, 3a) and multiple profiles 50 can be combined to generate a “point” cloud 52. (FIG. 3b)

The point cloud generated in FIG. 3b is only one part of the entire object 46 (orange) being scanned. The scanner currently outputs up to 660 data-points/sec×200 scans/sec totaling 0.5M points/sec sent to a processor. To process this amount of data quickly requires a parallel PC stack with cooling & large speedy computing power. (See FIG. 1a) The PC interface is then employed in converting the scanner output into information that allows the controller to operate industrial machinery. In order for this step to work, the PC interface must give the controller only what information it needs to perform its functions, and in a timely fashion.

A controller cannot process the point cloud, but it can perform limited operations depending on its onboard processing power and buffering capabilities. The controller is normally the interface between the wholesale data cloud and the retail operation and management of industrial machinery. Controllers permit many forms and formats of digital/analog input/output and can do some rudimentary calculation on input data. The controller must be able to perform its calculations and provide meaningful output within a loop that typically varies between 10 ms and 100 ms, so that the machinery can operate optimally. The point is that there is a short, finite period of time during which a controller must be presented with appropriate shape data and react to it. For example, if a pizza on a conveyor belt is detected as being too misshapen to be stacked properly in a freezer, a go or no-go decision among many must be made in time to allow an operator, whether human or automated mechanical, to take appropriate action. If a controller is presented with a massive data cloud from multiple scanner outputs and is stalled for example by taking a mere 100 ms to process the data in one of the above-noted loops in order to derive some actionable output—then the surrounding industrial process fails.

In an industrial production environment, a scanner data to controller interface based system has an inherent bottleneck that can slow slowing the entire process to a halt. Meaningful extraction of key information from each scan profile is necessary for efficient controller operation, and is made possible by scan data pre-processing tools (IET) incorporated into the 3D scanner unit, and described next.

### Profile Extraction:

Extracting key information from profile (X-Y) scan data is the overall purpose of the information extraction tools (IET) embedded in the improved 3D machine vision scanner. IET software extracts selected information from each X-Y profile as required by the industrial process performed, and then transmits only this data in CIP format to the controller. IET allows direct interface with the controller, eliminating costly, time consuming and expertise-driven PC interface analysis & processing. IET performs generic functions that condense or summarize data, yet are also configurable to each specific task. Information extraction tools include, but are not limited to the following methods: Extrema Derivation, Profile Tracking/Matching, Area Summing, Down-Sampling, and Multi-Region Scanning, and will now be described.

### Extrema Derivation:

Extrema are derived from 2D profile scans in order to assemble a manageable 3D dataset for rapid and accurate controller output. Of the 660 points available from each X-Y profile multiplied by a typical 200 scans generated every second, four key data points are selected: (X min, Y) (X max, Y) (X, Y min) (X, Y max). (see FIG. 7) As demonstrated in FIG. 4a the circled points are the extrema for each profile scan. The fourth point is not shown, but it is available as there is a coincidence of max and min at one point. In FIG. 4b, one can see that the data load on the controller now is much less than before. As is illustrated in FIGS. 5a & 5b, one can extract cloud extrema from the profile extrema, but this is done by the controller, with industrial environment parameters such as Over/Under Height, Over/Under Width, sorting by size etc., are the only information that is required because the extracted data is optimal for efficient controller operation. Examples of the steps of extrema derivation are shown in FIGS. 3a to 5b for a spherical orange, and FIGS. 6a to 6c for a frozen pizza. FIG. 7 shows graphically how extrema are derived from a profile scan.

### Curvature Maxima:

The Curvature IET is a curvature reporting tool that reports locations in each profile scan 50 of maximum curvature, namely the two highest concave locations (antipexes; 94 & 96) and two highest convex locations (apexes; 98 & 100) as shown on FIG. 12. FIG. 11c shows how scan cloud data 52 is processed by the curvature maxima IET 70 to streamline decision processing data 86 sent to the controller 34 by means of the Ethernet IP 28. Calculation of curvature maxima may be fine-tuned by selecting appropriate first difference span (FIRST_DIFF_SPAN) and discontinuity threshold (DISCONTINUITY_THRESH) parameters. FIRST_DIFF_SPAN is used while calculating the first difference (slope) of a line by the Curvature IET. For a data point in question the first difference is calculated using the data points that are plus or minus FIRST_DIFF_SPAN from the point in question. Increasing FIRST_DIFF_SPAN will smooth the data. With DISCONTINUITY_THRESH, the curvature IET will only calculate the curvature for a point if all of the points within FIRST_DIFF_SPAN are less than DISCONTINUITY_THRESH away. The first difference span parameter may be selectable by a user or by preprogrammed settings. Selecting the parameter results in the IET curvature reporting tool calculating a curvature for a selected curvature point on the profile scan using scan data points that are plus or minus the first difference span parameter from the selected curvature point. The discontinuity threshold parameter is likewise but separately selectable, by which the curvature reporting tool will only calculate the curvature for the selected curvature point on the profile scan only if all scan data points that are plus or minus the first difference span from the selected curvature point are located less than the selected discontinuity threshold parameter.

### Profile Tracking/Matching:

Another method of profile data extraction employs detecting the difference from selected or nominal profile. FIG. 8a shows a section of a corrugated pipe which has a dent. As the laser passes over the dent the profile detected shows a divergence from the nominal profile. This is illustrated graphically in FIG. 8b which represents the onboard processing done to detect the dent. One may wish to detect divergence from within some range of tolerance for the existing profile, but the actual dimensions do not matter, or one may wish to detect whether the scanned profile matches a specific profile template. This method of data extraction can be utilized for any regular longitudinal shape such as plastic extrusions or rolled metal pipes

### Area Summing:

This method employs taking multiple cross sections (profiles) of a mass of aggregate elements such as woodchips, cereal, flour, ores, etc. As can be seen in FIGS. 9a to 10b, profiles are derived and then areas summed and added within the controller rather than the scan head, to generate a total estimated volume. The invention by providing key information from the scan head rather than massive scan point data to the controller allows the calculation by the controller of additional information that would be normally very difficult to obtain. An example would be automatically deriving moisture content when one knows how much an aggregate with variable water content weighs and its volume is calculated in real-time by the controller attached to the invention. Water content-critical applications such as baking preparation, cement-making, or freezing of baked goods for storage in a limited volume of freezer space require the operator to know how much water to add to his mix and the system enables the correct adding because the timely scan information provided by the present system allows the controller to tells the operator how much moisture is already in the mixture.

### Down-Sampling:

This data extraction method employs reducing the amount of output sent to the controller by reducing the number of points released from any profile sample. For example, a profile scan of 660 points can be reduced to 16 points transmitted to the controller.

### Multi-Region Scanning:

This method is employed when there are a discrete number of objects placed in specific known regions of a scan zone. For example, when scanning a conveyor belt of cookies, 3-5 cookies are measured at a time for diameter or height or shape. Extrema may be generated for each cookie and if any are defective they are removed.

### Other Methods:

Any methods that allow one to reduce the data from an X-Y profile may be employed if they are required to operate a controller. For example, in “web control” applications, such as the winding of fabric or carpet, edge tracking is necessary, but the full scan data of a large spool of material is unnecessary—only information from scanning the position of the edge of potentially wayward rolling material would be required to detect “spilling” beyond a range of rolling edge position tolerance The sooner a variance from the intended path is detected, the easier it would be to correct, so the edge of a carpet that is being rolled, for example, would be scanned and monitored not just at the spool itself but also along an extent of carpet edge that is yet to reach the spool. The ongoing edge position information would be fed to a process controller which could then take electronic steps to cause mechanical correction of the rolling process.

The system can supply and apply IETs to data from a single profile or from a pre-determined fixed range or number of scans in the Z axis, or alternatively from a variable range of profiles in the Z axis. For example, it could be decided (by the controller) that the lowest point from 5,000 scans should be passed to the controller. The range can be selectable by the controller, or could be varied automatically based on scan information previously received from target objects in the scan zone. For example, the width of pizzas moving on a conveyor could be crucial to decisions about sorting. The efficient way to extract and pass the relevant information from the scan data would be to have the information extraction module in the scan head pass on only each pizza width, which can be determined only after assessing multiple profiles for each pizza. The range of such multiple profiles to be used to determine pizza width could be selected by working downward from the entirety of scan profiles of the first few pizzas in a batch to a mid-pizza range of profiles that invariably contained the widest part of the pizza. An apt information extraction tool selected by the controller is thus applied to scan data from a controller-selectable range of number of scan profiles. Resulting scan information is transmitted to the controller, before the information extraction tool is applied to the raw data of a subsequent range of scan profiles.

### Decision Processing:

Prior art solutions employing PC interfaces provided a workstation to select parameters for analysis and processing of raw scan data. 3D Machine Vision Scanning Information Extraction scanning eliminates the middleman, in that due to a significantly reduced data transfer, extraction parameters can be selected within the controller's application solutions. Selection and optimization of IETs is done via existing development tools for controller. (industrial application development environment IADE) Add-on profiles have been developed for the 3D Machine Vision Scanning Information Extraction System so that IETs can be selected within existing IADE tools. (Extrema, scan rate, selection parameters, etc.)

### Connections:

These can include an Interface with a TCP/IP stack or EtherNet/IP. Either can pass information to a controller.

### Controllers:

In the field of automated industrial control and in this Specification and the appended Claims, “controller” means a device that can be programmed to control industrial processes. Examples would be: a mainframe computer, a personal computer (PC), a Programmable Logic Controller (PLC), or a Programmable Automation Controller (PAC).

A logical alternate embodiment of the 3D Machine Vision Scanning Information Extraction System is to apply IETs to data along the Z-axis, one scan profile at a time, or to a range of profiles if it is a range that would contain the desired scan information to be extracted from the data. Other embodiments are not ruled out or similar methods leading to the same result.

Other advantages of using the 3D Machine Vision Scanning Information Extraction System over other methods or devices will now be described.

An Integrated 3D scanner is a standard off-the-shelf component and may be used in this invention to provide the raw scan data. The. IETs functions to generate the key target object scan information in a standard output format to the controller so that it can digest the information and act quickly. The Integrated 3D scanner provides self-contained, integrated, non-contact, true 3D machine vision scanning. Integrated illumination, imaging and processing.

An advantage of using controllers such as PLCs and PACs is that they are industry standard to operate machinery and do not require highly customized programming. An advantage of allowing scan parameters to be selected with industry standard controller development tools is that alterations do not require a programmer, only someone familiar with the IADE controller development environment.

IET within CIP removes complexity of 3D scanning & control. IET's are generic and can be used for multiple industry applications because application decision processing is done by the programmable automation controller (PAC) or programmable logic controller (PLC). The application solution key information extraction from scan data is done in the scanner head but the kind of key information is selected with controller development application. Handing the information off via EtherNet/IP within CIP is a prime example for the invention, but the system would work with any open standard communication protocol.

The IET process can extend beyond summaries of data points. For example, a scanner head is often required to be mounted in an industrial setting such that the scan head's X-Y-Z coordinates are not coincident with its industrial environment's X-Y-Z coordinates. For example, the scan head might be mounted to a pole adjacent to a conveyor belt, or if the scan head of the present invention is not aligned with and perpendicular to a selected region of interest in the scan zone. Besides the data reduction to key scan information, the computational electronics of the scanner head can perform transformational calculations to simplify matters for a common industrial controller. The information extraction module would thus perform orientation adjustment calculations on X and Y data points and pass orientation adjusted target object information to the controller. The orientation adjustment calculations could be rotation or translation calculations, or both, depending on the location orientation of the scan head's own coordinates with respect to the real world industrial environment (setting) coordinates in which the scan head is mounted and used.

The system is resilient enough to be configured to scan anything available without requiring excessive programming knowledge or processing power. Anyone who understands the controller application environment can control the scanning process efficiently; they do not need to know what is going on inside because pre-processing (IET) permits a simpler smaller manageable dataset.

The system of the present invention can be implemented with multiple scan heads mounted in different orientations that are synchronized in order to provide information from geographically opposed regions of interest on a target object. For example, IET regarding the shape of a log in a saw mill may require four scanners mounted on four corners of a frame through which the log is passed longitudinally.

The foregoing description of the preferred apparatus and method of operation should be considered as illustrative only, and not limiting. Other data extraction techniques and other devices may be employed towards similar ends. Various changes and modifications will occur to those skilled in the art, without departing from the true scope of the invention as defined in the above disclosure, and the following general claims.

We claim:

1. A 3D machine vision scanning system having:
a) a scanner head for obtaining raw scan data from a target object,
b) an information extraction module that processes and reduces the raw scan data into target object information that is to be used for automated control decisions in an industrial process, and
c) a communication interface for transmitting the target object scan information to a controller.

2. The 3D machine vision scanning system of claim 1 in which the scanner head contains:
a) a laser light emitter and a reflected laser light detector;
b) the information extraction module that processes and reduces raw scan data into target object information that is significant for control decisions in an automated industrial process, and
c) the communication interface for transmitting the target object scan information to a controller.

3. The 3D machine vision scanning system of claim 1 in which the scanner head contains:
a) a laser light emitter and a reflected laser light detector;
b) an electronic scan data processor having a set of embedded mathematical functions to extract key target object information from scan data, for reduction of data transmission and reduction of complexity of subsequent processing and decision analysis in an industrial control system.

4. The 3D machine vision scanning system of claim 1, in which key scan information extraction tools include a multiplicity of predefined, controller-selectable regions of interest.

5. The 3D machine vision scanning system of claim 1, in which an information extraction tool is applied to scan data from a controller-selectable range of number of scan profiles, and resulting scan information is transmitted to the controller, before the information extraction tool is applied to a subsequent number of scan profiles selected.

6. The 3D machine vision scanning system of claim 1, combined with multiple like scanner heads connected to a communication multiplexer that passes extracted target object scan information to a controller.

7. The 3D machine vision scanning system of claim 1, in which a set of scan information extraction tools, comprising at least one of:
a) an extrema derivation tool,
b) a profile tracking tool,
c) a profile matching tool, and
d) an area summing tool
is integrated into a scanner head.

8. The 3D machine vision scanning system of claim 6, in which a time division multiplexer encoder enables communication from multiple scanner heads to a controller and includes timing synchronization so each scanner can be phase locked.

9. The 3D machine vision scanning system of claim 1, in which data reduction is performed on successive data profiles, each data profile being a series of imaged points on an X-axis and a Y-axis, the successive data profiles being on a Z-axis to make up an entire 3D scan of a portion of a target object that is visible to the scanner.

10. The 3D machine vision scanning system of claim 1, in which laser triangulation is used to image the intersection of an object and a reference laser beam to generate X-Y slice profiles that are then combined incrementally along a Z-axis into a 3D raw data point cloud representation.

11. The 3D machine vision scanning system of claim 1, in which a scanner head that extracts key scan information from raw profile (X-Y) scan data passes to the controller only the scan information that the controller needs to perform its functions.

12. The 3D machine vision scanning system of claim 1, in which key target object scan information is formatted within a scanner head into an open standard communication protocol.

13. The 3D machine vision scanning system of claim 1, in which a scan head's X-Y-Z coordinates are not coincident with its industrial environment X-Y-Z coordinates and the information extraction module performs orientation adjustment calculations on X and Y data points and passes orientation adjusted target object information to the controller.

14. The 3D machine vision scanning system of claim 13, in which the controller can remotely set orientation adjustment calculation parameters for the information extraction module to use in performing the orientation adjustment calculations on X and Y axis data points.

15. The 3D machine vision scanning system of claim 1, in which multiple scanner heads are mounted in different orientations and are synchronized in order to provide information from different regions of interest on a target object.

16. The 3D machine vision scanning system of claim 1, in which the information extraction module applies an information extraction tool to scan data from a range of scans in the Z axis.

17. The 3D machine vision scanning system of claim 2 in which:
a) the scanner head is a sealed scanner head contains a laser light emitter and a reflected laser light detector and an electronic scan data processor having a set of embedded mathematical functions to extract key target object information from scan data;
b) a computation method to be used by the information extraction module is selectable by the controller choosing from among a set of key scan information extraction tools;

18. The 3D machine vision scanning system of claim 17, in which:
a) key scan information extraction tools include a multiplicity of predefined, controller-selectable regions of interest
b) an information extraction tool is applied to scan data from a controller-selectable range of number of scan profiles, and resulting scan information is transmitted to the controller, before the information extraction tool is applied to a subsequent number of scan profiles selected.

19. The 3D machine vision scanning system of claim 18, in which:
a) the scanner head extracts key scan information from raw profile (X-Y) scan data and passes to the controller only the scan information that the controller needs to perform its functions;
b) the key target object scan information is formatted within the scanner head into an open standard communication protocol.

20. The 3D machine vision scanning system of claim 18, in which the scanner head is combined with multiple like scanner heads mounted in different orientations and connected to a communication time division multiplexer that includes timing synchronization so each scanner head can be phase locked and synchronized and pass extracted target object scan information about different regions of interest on a target object from the scanner heads to a controller.

21. A 3D machine vision scanning system having:
a) a scanner head for obtaining raw scan data from a target object,
b) an information extraction module that processes and reduces the raw scan data into target object information that is to be used for automated control decisions in an industrial process, and
c) a communication interface for transmitting the target object scan information to a controller.
in which a set of scan information extraction tools, comprising a curvature reporting tool, is integrated into the scanner head.

22. The 3D machine vision scanning system of claim 21, in which the set of scan information extraction tools, comprises additionally at least one of:
a) an extrema derivation tool,
b) a profile tracking tool,
c) a profile matching tool,
d) an area summing tool.

23. The 3D machine vision scanning system of claim 21, in which the curvature reporting tool reports locations of maximum curvature in profile scans.

24. The 3D machine vision scanning system of claim 23, in which maximum curvature locations are calculated using two highest concave locations and two highest convex locations in profile scans.

25. The 3D machine vision scanning system of claim 23, in which a first difference span parameter is selectable by which a curvature for a selected curvature point on the profile scan is calculated using data points that are plus or minus the first difference span parameter from the selected curvature point.

26. The 3D machine vision scanning system of claim 25, in which a discontinuity threshold parameter is selectable by which the curvature reporting tool will only calculate the curvature for a point on a profile scan only if all data points that are plus or minus the first difference span from the selected curvature point are less than the discontinuity threshold parameter.
